(19) United States
(12) Patent Application Publication
(10) Pub. No.: US 2010/0228745 A1
(43) Pub. Date: Sep. 9, 2010

(54) SYSTEM, METHOD, AND APPARATUS FOR SORTING AT LEAST PARTIALLY DYNAMIC DATA

(75) Inventors: Aris Anagnostopoulos, San Francisco, CA (US); Shanmugasundaram Ravikumar, Berkeley, CA (US); Mohammad Mahdian, Santa Clara, CA (US); Eli Upfal, Providence, RI (US)

Correspondence Address: BERKELEY LAW & TECHNOLOGY GROUP LLP, 17933 NW EVERGREEN PARKWAY, SUITE 250, BEAVERTON, OR, 97006, US

(73) Assignees: Yahoo!, Inc., a Delaware Corporation, Sunnyvale, CA (US); Brown University, Providence, RI (US)

(21) Appl. No.: 12/396,910

(22) Filed: Mar. 3, 2009

(51) Int. Cl. G06F 17/30

(52) U.S. Cl. 707/752; 707/E17.104

(57) ABSTRACT

Embodiments of methods, apparatuses, devices and systems associated with sorting candidate values are disclosed.

### FIELD

Embodiments relate to the field of sorting candidate values.

### Information

In a typical computing paradigm a process may receive input at the start of the computation and compute a function result relating to such input. As computing has become more interactive, researchers have developed the theory of online processes, focusing on the tradeoff between the timely availability of an input and the performance of the process. Accordingly, it may be desirable to have computational models, systems, or processes associated with dynamic data

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flow chart of a process in accordance with an embodiment;

FIG. 2 is a schematic diagram of an embodiment, such as one or more computing platforms;

FIG. 3 is a schematic diagram of a computing platform.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

At least one embodiment relates to a computational model associated with dynamic data. For example, dynamic data may comprise data that changes gradually over time. For additional example, dynamic data may include data that tends to vary over time due at least in part to changes in the underlying data or changes in perception of the underlying data, such as opinion polls with multiple candidates or web pages or web sites the content of which may change over time. In an embodiment, a system or process may determine one or more properties or characteristics of dynamic data at a particular time, while only having limited access to such dynamic data. For example, one particular embodiment relates to sorting and selection of a dynamic data set, such as a data set which where individual portions of the data set may have ranks or orderings with may change gradually over time.

In one computing paradigm a process may receive one or more input values at the start of the computation and compute a function result relating to such input values. As computing has become more interactive, researchers have developed one or more theory relating to online processes, focusing on a tradeoff between timely availability of input information or values and one or more performance characteristics of such processes. One or more embodiments relate to one or more aspects of on-line, interactive computing, such as determining and maintaining information in the presence of changing data. An example of such changing data may include online voting websites, such as Bix (www.bix.com). In this example, the Bix website may, from time to time, host online contests for various themes, such as the most entertaining sport, the most dangerous animal, or the best presidential nominee, in which users may vote to select the best amongst a pre-specified set of candidates. For a given contest, Bix may display a pair of candidates to a user visiting the website and asks the user to rank or order such a pair of candidates. In this circumstance, the candidates and their respective ranks may be considered a dynamic data set. As such a contest progresses, Bix may aggregate such pairwise comparisons provided by users to pick the leader (or the top few leaders) of the contest thus far to at least in part reflect the aggregated opinion of the users.

In at least one embodiment, as such a contest progresses, a voting patterns of the various user, or under some circumstances individual users, may change over time, perhaps slowly, at an aggregate level. This can be caused by an intrinsic shift in opinion among users about the candidates or factors external to the contest. Accordingly, it should not necessarily be assumed that there is a fixed ordering or ranking of candidate values in such a voting contest that the contest is trying to uncover, however, it is reasonable to assume that the order, relative value, or ranking of the candidate values changes slowly over time. In at least one embodiment, whenever a user visits such a website, the website or a computing platform associated with the website may select a pair of candidate values or contestants to display to the user in order to elicit a comparison or relative ranking of the pair of candidates. Under these circumstances, by revealing a preference a visiting user is thus a valuable resource. Therefore, such a web site may be inclined to judiciously utilize such a user resource by displaying a pair of candidates that yields an advantageous benefit and value.

One way to model the above scenario is as follows. At least one embodiment may involve a data set having n total elements and having an underlying order, relative value, or ranking of those n element at a particular time. In this example, the elements within the data set may continue to change over time. In addition, a relative ranking or order of those elements may also continue to change over time. In this example, a relatively slow change to the data set may at least in part be accounted for by assuming that a change of order, relative value, or ranking of a particular element in a data set relative to other elements of the data set between an initial order and a modified order may be relatively small. In at least one embodiment, a process, at any point in time, may track a few of the relatively higher ranked elements of the underlying current order, relative value, or ranking or more generally, maintain an approximate order, relative value or ranking for those elements that is close to the actual modified order, relative value, or ranking of those elements at any particular time. In at least one embodiment, the process may utilize one or more pairwise comparison probes of some elements of the data set. In this embodiment, a pairwise comparison or pairwise comparison probe may comprise a comparison or ranking of two elements within the data set. For example, a system or process may choose two elements from the data set and compare or rank those elements through one or more processes, such as a machine or user ranking. For example, at a given point in time, a system or process may obtain a pairwise ranking of a pair of elements, such as by displaying the pair of elements to a user for ranking and receiving a signal associated with such a user ranking or by performing a machine ranking process on those elements. In this embodiment, a system or process may choose a particular pair of elements for a pairwise ranking based at least in part on an underlying order, relative value, or ranking of the elements of the data set currently in use by the process or system. In this example, there may be a tradeoff between a number of pairwise comparison probes that can be made at a particular time and, a relative accuracy of the approximate underlying order, relative value, or ranking of the elements of the data set. As yet another example, consider an application program, such as web crawler. In this example, a web crawler's goal may be to track one or more relatively high quality web pages on a network, such as the Internet. In this example, quality may refer to a number of times a web page is visited or linked to, an evaluation of content of a web page, or any other desirable ranking characteristic. In this embodiment, quality may vary over time, such as due to changes in perceived value by users, changes in number of web pages linking to a particular web page, or modification to the content of a particular web page, to name but a few examples. Furthermore, in this embodiment a web crawling application may have only limited access to a particular network at any point in time due to a variety of factors including availability of resources or resource constraints. In this example, such a web crawler may attempt track web pages having a quality that is reasonably close to a quality of a currently highest or relatively highest ranking. Yet another example to consider may comprise maintaining routing tables for a network. Such routing tables may include information relating to various aspects of available routes, such as congestion along certain routes. In this example, congestion along particular routes may change gradually over time, and a router may receive new information on a particular route's congestion only when a packet is sent along that route. Yet another example may be that of a company that wants to track popular social network users with a lot of friends, such as to use information about users having a relatively large number of friends for one or more purposes, such as viral marketing purposes. Social networking systems such as Facebook allow users or processes to query and find the contacts or friends linked to for a given user (unless a particular user does not allow such queries). Such queries may be used at least in part to perform one or more pairwise comparisons of various users and their respective number of friends. However, such social networking system may limit such queries at least in part based on one or more terms of use associated with a particular system. Accordingly, a user, system or process may have only a limited quantity of such queries available at a particular time to determine an approximate order, ranking, or relative value of various users. Additional examples may include other scenarios such as continually updated remote databases, hashing, load balancing, such as within distributed computing systems, polling, or the like. It should be noted that these are merely illustrative examples relating to sorting dynamic data and that claimed subject matter is not limited in this regard.

For illustrative purposes, consider a universe of n elements U={u1, u2, . . . , un}. In an embodiment, an order for the elements of U may change over time due at least in part to one or more dynamic processes, such as user voting or ranking, for example. In this embodiment, an order, relative value, or ranking of the elements of U may change gradually over time, and, under some circumstances, such change may be approximated or determined by assuming that at any time period t, after sorting has begun, that an order of the elements of U at a particular time period may be obtained from an order of the elements of U at a previous time period at least in part by swapping a random pair of consecutive elements of U at that previous time period. Here, in this example, t refers to a particular time, such as a time at which an order, relative value, or ranking of the elements of U may have changed. In at least one embodiment, a process or system may estimate an order, relative value, or ranking of the elements of U at a particular time t. At one or more times, such a process may select two elements of U to compare, such as a user or machine process of ranking the selected two elements. The ordering of these two elements according to time t is given to the process, and then the process computes an estimate of an actual order, relative value, or ranking of the elements of U. In at least one embodiment, the process or system may store one or more portions of information which, under some circumstances, may be carried over to one or more subsequent actions by the system or process, such as to allow the system or process to track an approximate order, relative value, or ranking of the elements of U. In this example, it is assumed that a rate of comparisons performed by a system or process by the process is equal to a rate of change in the actual order, relative value or ranking of the elements of U. However, it should be noted that this assumption was merely made for simplicity of this particular example, and that claimed subject matter is not limited to this particular example.

In at least one embodiment. A system or process may execute a normal quicksort process to sort all elements of a data set. As used herein a quicksort may refer to a process by which one or more elements of a data set are compared to each other. For example, a quicksort may compare elements of a data set to a particular pivot value of that data set. A pivot value as used herein may refer to a value around which other values within a data set may be organized, such as by determining a relative value of other data elements relative to the pivot value. At any time step, such a process may provide an order, relative value, or ranking of the elements of a data set that is obtained at the end of a previous process. In at least one embodiment, results of such a quicksort may be improved at least in part by executing one or more additional sorts of one or more subsets of the data set. In this example, the one or more additional sorts of one or more subsets of the data may comprise quicksorts of those subsets. In an embodiment, such one or more subsets may be a portion of such a data set. In at least one embodiment, such one or more subsets may be at least partially intersecting, such that one or more elements in a particular subset may also be included in at least one other subset. In at least one embodiment, it may be desirable to occasionally execute a quicksort of all elements within a particular data set to determine a current order, relative value, or ranking of the elements of the particular data set. However, during the execution of such a quicksort of all the elements within a particular data set error may be introduced into the output of the quicksort. In at least one embodiment, such error may be addressed at least in part by executing two sets of quicksorts independently. For example, a system or process may execute a regular quicksort at one or more particular times, such as times having odd numerical values. In this example, a system or process may also execute a set of quicksorts on at least partially intersecting sets of elements from the data set at one or more other particular times, such as times having even numerical values. In at least one embodiment, an input to the set of quicksort operations applied to the at least partially intersecting subsets of the data set may be an order determined by a previously completed quicksort of all the elements of the data set. In such an embodiment, after completion of the set of quicksorts of the at least partially intersecting subsets of the data set, a system or process may again perform a set of quicksorts of the at least partially intersecting subsets of the data set using the same input as with the previous execution. It should, however, be noted that these are merely illustrative examples relating to a sorting process and that claimed subject matter is not limited in this regard.

Embodiments relate to system, apparatuses an processes associated with sorting or ranking dynamically changing data. For example, embodiments may relate to a variety of circumstances including, but not limited to on-line voting, web crawling, social networks, or the like. In at least one embodiment, an applicable data set may, under some circumstances, gradually change over time and in at least one embodiment a system, apparatus of process may determine one or more properties of such a dynamic data set. For example, a system or process may probe such a dynamic data set, such as by using one or more pairwise comparisons. In addition, a system or process may use one or more sorting processes from time to time to organize such a dynamic data set. It should, however, be noted that these are merely illustrative examples relating to operating with such dynamic data sets and that claimed subject matter is not limited in this regard.

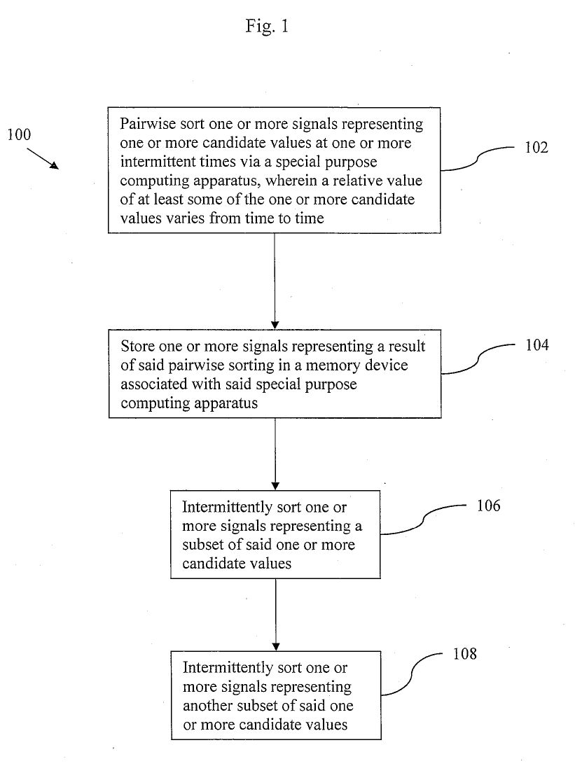

FIG. 1 is a flow chart of a process 100 in accordance with at least one embodiment. With regard to box 102, a system or process may pairwise sort one or more signals representing one or more candidate values at one or more intermittent times via a special purpose computing apparatus, wherein a relative value of at least some of the one or more candidate values varies from time to time. For example, a system or process may from time to time perform a sort of signals representing candidate values in a data set, such as one or more choices a user may rank in an on-line voting competition, or the like. In at least one embodiment, such a sort may comprise executing a quicksort of one or more pairwise comparisons of the candidate values. For example, a user may be presented with a pair of candidate values and asked to rank those candidate values relative to one another. In an embodiment, a particular candidate value, such as a pivot value, may be successively compared to multiple other candidate values, so as to at least in part determine a relative order of elements of a data set. With regard to box 104, a system or process may store one or more signals representing a result of said pairwise sorting in a memory device associated with said special purpose computing apparatus. With regard to box 106, a system or process may intermittently sort one or more signals representing a subset of said one or more candidate values. For example, a system or process may from time to time perform a sort of one or more signals representing a first subset of one or more candidate values. In at least one embodiment such a sort of a subset may comprise performing or executing a quicksort of one or more comparisons of signals representing the subset of candidate values. For example, a user may be presented with one or more pairs of candidate values from the subset and be asked to compare or rank those candidate values, such as by providing feedback through a web browser. With regard to box 108, a system or process may intermittently sort one or more signals representing another subset of said one or more candidate values. In an embodiment, the second subset of the one or more candidate values may at least partially intersect with the first subset of candidate values. Here, the sort of the second subset may be similar to the first subset. For example, such a sort may comprise performing or executing a quicksort of signals representing the candidate values in the second subset. In an embodiment, a user, such as a user accessing a web site, may be presented with one or more pairs of candidate values from the second subset and be asked to compare or rank those values. Such a process may continue for a plurality of users so that over time users may rank candidate values during a quicksort of all the candidate values or during various sorts of subsets of candidate values. In one embodiment the subsets of candidate values may be created from a previous result of a quicksort of all candidate values. Likewise, a subsequent quicksort of all candidate values may use one or more results from a quicksort of one or more of the subsets of values as a starting point. It should, however, be noted that these are merely illustrative examples relating to sorting candidate values and that claimed subject matter is not limited in these regards.

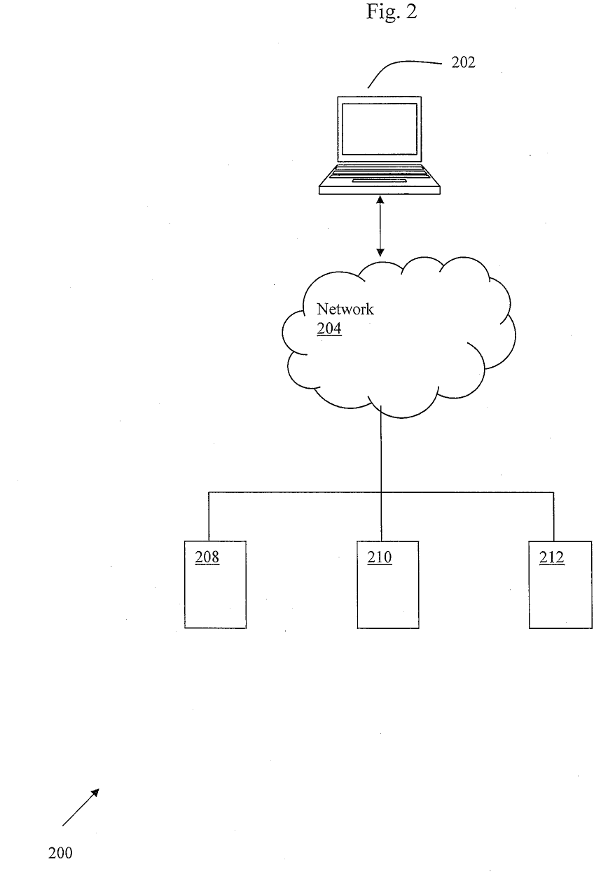

FIG. 2 is a schematic diagram of a system 200 in accordance with an embodiment. With regard to FIG. 2, a user may access one or more websites, such as by using computing platform 202 to access a website over network 204 from another computing platform, such as computing platform 208. In an embodiment, computing platform 208 may from time to time provide users with one or more candidate values, such as for performing a pairwise comparison of candidate values. For example, computing platform 208 may present a user with an online voting web site and ask a user to rank one or more pairs of candidate values, such as candidates in an online voting contest. In one embodiment, computing platform 208 may present a user with candidate values for comparison as part of one or more of the sorts discussed above with regard to FIG. 1. For example, computing platform 208 may present a user with candidate values as at least a part of a quicksort of all candidate values. For additional example, computing platform 208 may present a user with candidate values as a least a part of a quicksort of one or more subsets of candidate values. In addition, computing platform 210 may, under some circumstances, host a web crawler or other application program. In this example, computing platform 210 may access one or more web sites and perform one or more pairwise comparisons to rank such web sites in a manner similar to that described above with regard to FIG. 1. For example, the web crawler may present a pair of potential web sites for comparison or ranking. In addition, computing platform 208 or 210 may store one or more comparison results, such as by transmitting those results to computing platform 212 for storage. It should, however, be noted that these are merely illustrative examples relating to comparing, sorting, or ranking candidate values and claimed subject matter is not limited in these regards.

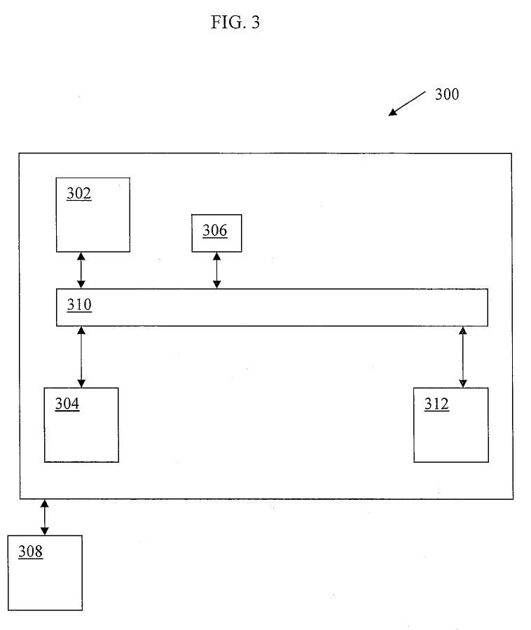

FIG. 3 is a depiction of a computing platform 300 in accordance with an embodiment. With regard to FIG. 3, computing platform 300 may comprise a computing platform adapted to sort at least partially dynamic data sets, such as candidate values for an online voting website, social networking information, web pages ranked by a web crawler or the like. In addition, computing platform 300 may comprise one or more processors, such as processor 302. Furthermore, computing platform 300 may comprise one or more memory devices, such as storage device 304 or computer readable medium 306. In an embodiment, computing platform 300 may be operable to store one or more signals representing one or more candidate values, comparisons of candidate values, or sorts of candidate values. In addition, computing platform 300 may comprise one or more network communication adapters, such as network communication adaptor 308. In an embodiment, computing platform 300 may be operable, at least in part in conjunction with network communication adaptor 308, to send or receive signals representing one or more candidate values, comparisons of candidate values, or sorts of candidate values via one or more networks. Computing platform 300 may also comprise a communication bus, such as communication bus 310, operable to allow one or more connected components to communicate under appropriate circumstances. In an embodiment, communication adapter 308 may be operable to send or receive signals representing one or more candidate values, such as for pairwise comparisons at least as a portion of one or more of the sorting processes described above. In addition, communication adapter 308 may be operable to send or receive one or more signals corresponding to rankings based at least in part on the pairwise comparisons of candidate values. In an embodiment, computing platform 300 may be operable to store signals representing one or more results corresponding to one or more of the sorting processes described above. It should, however, be noted that these are merely illustrative examples relating to a computing platform and that claimed subject matter is not limited in this regard.

Some portions of the detailed description above are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer, special purpose computing apparatus, or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

1. A method comprising:
pairwise sorting one or more signals representing one or more candidate values at one or more intermittent times via a special purpose computing apparatus, wherein a relative value of at least some of the one or more candidate values varies from time to time; and
storing one or more signals representing a result of said pairwise sorting in a memory device associated with said special purpose computing apparatus.

2. The method of claim 1, wherein said sorting comprises executing a quicksort of a signal representing a first candidate value relative to one or more signals representing one or more other candidate values.

3. The method of claim 2, wherein said signal representing a first candidate value comprises a signal representing a pivot value associated with the one or more candidate values.

4. The method of claim 2, and further comprising:
intermittently sorting one or more signals representing a subset of said one or more candidate values.

5. The method of claim 4, wherein said sorting one or more signals representing a subset of said one or more candidate values comprises executing a quicksort of said one or more signals representing said subset of said one or more candidate values.

6. The method of claim 4, and further comprising:
intermittently sorting one or more signals representing another subset of said one or more candidate values.

7. The method of claim 6, wherein said one or more signals representing another subset contains one or more signals representing at least some values also contained in said subset.

8. An article comprising: a storage medium having stored thereon instructions that, if executed by a special purpose computing apparatus, enable said special purpose computing apparatus to:
pairwise sort one or more signals representing one or more candidate values at one or more intermittent times, wherein a relative value of at least some of the one or more candidate values varies from time to time; and
store one or more signals representing a result of the pairwise sort in a memory device associated with said special purpose computing apparatus.

9. The article of claim 8, wherein said instructions, if executed by said special purpose computing apparatus, further enable said special purpose computing apparatus to sort one or more signals representing one or more candidate values at least in part by executing a quicksort of a signal representing a first candidate value relative to one or more signals representing one or more other candidate values.

10. The article of claim 9, wherein said signal representing a first candidate value comprises a signal representing pivot value associated with the one or more candidate values.

11. The article of claim 9, wherein said instructions, if executed by said special purpose computing apparatus, further enable said special purpose computing apparatus to intermittently sort one or more signals representing a subset of said one or more candidate values.

12. The article of claim 11, wherein said instructions, if executed by said special purpose computing apparatus, further enable said special purpose computing apparatus to sort said one or more signals representing a subset of said one or more candidate values at least in part by executing a quicksort on said said one or more signals representing a subset of said one or more candidate values.

13. The article of claim 12, wherein said instructions, if executed by said special purpose computing apparatus, further enable said special purpose computing apparatus to intermittently sort one o more signals representing another subset of said one or more candidate values.

14. An apparatus comprising:
a computing platform;
a communication adapter operable to send or receive one or more signals representing one or more candidate values;
wherein said computing platform is operable to sort said one or more signals representing one or more candidate values at one or more intermittent times, wherein a relative value of at least some of the one or more candidate values varies from time to time;
wherein said computing platform is further operable to store one or more results of the sort in a memory device.

15. The apparatus of claim 14, wherein said computing platform is further operable to sort said one or more signals representing one or more candidate values at least in part by executing a quicksort of a signal representing a first candidate value relative to one or more signals representing one or more other candidate values.

16. The apparatus of claim 15, wherein said signal representing a first candidate value comprises a signal representing a pivot value associated with the one or more candidate values.

17. The apparatus of claim 15, wherein said computing platform is further operable to intermittently sort one or more signals representing a subset of said one or more candidate values.

18. The apparatus of claim 17, wherein said computing platform is further operable to sort said one or more signals representing a subset at least in part by executing a quicksort on said one or more signals representing a subset.

19. The apparatus of claim 18, wherein said computing platform is further operable to intermittently sort one or more signals representing another subset of said one or more candidate values.

20. The apparatus of claim 19, wherein said one or more signals representing another subset contains one or more signals representing at least some values also contained in said subset.
